(19) United States
(12) Patent Application Publication
(10) Pub. No.: US 2026/0008285 A1
(43) Pub. Date: Jan. 8, 2026

(54) THERMAL PRINTER

(71) Applicant: SEIKO EPSON CORPORATION, TOKYO (JP)

(72) Inventor: Takashi AOKI, SHIOJIRI-SHI (JP)

(21) Appl. No.: 19/260,332

(22) Filed: Jul. 4, 2025

(30) Foreign Application Priority Data
Jul. 5, 2024 (JP) 2024-108723

(51) Int. Cl. B41J 25/312; B41J 2/32; B41J 11/04

(52) U.S. Cl. CPC B41J 25/312; B41J 11/04; B41J 2/32; B41J 2202/31

(57) ABSTRACT

A thermal printer includes a thermal head 510 pivotably supported by the printer unit, a platen roller 520 disposed opposite to the thermal head 510 and transporting a recording sheet, a pressing member 610 that is provided on the side opposite to the platen roller 520 with respect to the thermal head 510 and that presses the thermal head 510 toward the platen roller 520, a support member 620 provided on a side opposite than the thermal head 510 with respect to the pressing member 610, and a pressing force adjustment member 630 disposed between the support member 620 and the pressing member 610 to adjust the pressing force of the pressing member 610.

The present application is based on, and claims priority from JP Application Serial Number 2024-108723, filed July 5, 2024, the disclosure of which is hereby incorporated by reference herein in its entirety.

### BACKGROUND

### 1. Technical Field

The present disclosure relates to thermal printers.

### 2. Related Art

JP-A-2009-90491 discloses a configuration in which, by inserting a spacer between an auxiliary plate and a holder, changing the distance between the auxiliary plate and the head support plate, and by changing the magnitude of the repulsive force of the compression spring, the pressing force against the platen roller of the thermal head can be changed.

However, the configuration described in JP-A-2009-90491 is a structure for adjusting by inserting a spacer between the auxiliary plate and the holder, and since the structure such as the number of parts is increased becomes complicated, a simplified adjustment means is desired.

### SUMMARY

A thermal printer includes a thermal head pivotably supported by a printer unit, a platen roller that is disposed opposite to the thermal head and that is configured to transport a recording sheet, a pressing member that is provided on a side opposite than the platen roller with respect the thermal head and that is configured to press the thermal head toward the platen roller, a supporting member provided on a side opposite than the thermal head with respect to the pressing member, and a pressing force adjustment member disposed between the supporting member and the pressing member and adjusts the pressing force of the pressing member.

### BRIEF DESCRIPTION OF THE DRAWINGS

FIG. 1 is a perspective view showing configuration of a thermal printer.

FIG. 2 is a perspective view showing configuration of a printer unit.

FIG. 3 is a perspective view showing configuration of the printer unit.

FIG. 4 is an enlarged cross-sectional view of part A of the printer unit shown in FIG. 3.

FIG. 5 is an enlarged perspective view showing configuration of a recording section depicted in FIG. 3.

FIG. 6 is a perspective view showing configuration of a pressing force adjustment member.

FIG. 7is a cross-sectional view showing configuration of the recording section in a state where pressing force of a pressing member is weak.

FIG. 8 is a cross-sectional view showing configuration of the recording section in a state where pressing force of the pressing member is strong.

### DESCRIPTION OF EMBODIMENTS

Hereinafter, the configuration of the thermal printer 1000 will be described with reference to the drawings. In each of the following drawings, three axes orthogonal to each other are described as an X axis, a Y axis, and a Z axis. A direction along the X axis is referred to as an "X direction", a direction along the Y axis is referred to as a "Y direction", a direction along the Z axis is referred to as a "Z direction", a direction indicated by an arrow is referred to as a + direction, and a direction opposite to the + direction is referred to as a -direction.

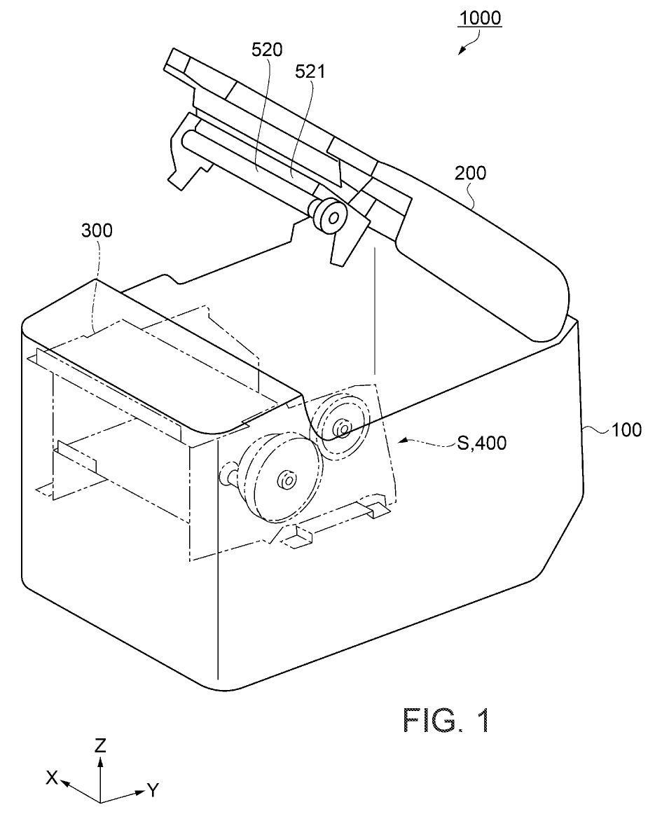

First, the configuration of the thermal printer 1000 will be described with reference to FIGS. 1 to 3. FIG. 1 shows a state in which a cover 200 is open with respect to a device body 100.

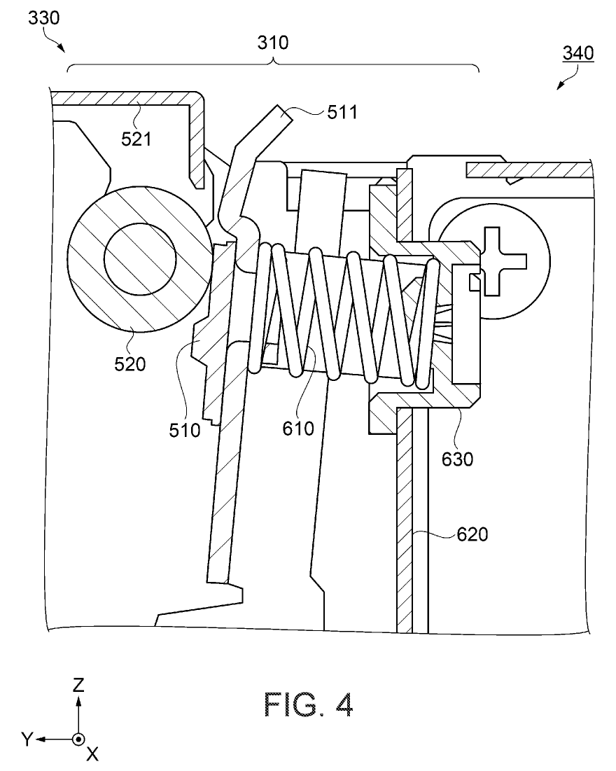

As shown in FIG. 1, the thermal printer 1000 is applied to a receipt printer used in a POS system, for example. The thermal printer 1000 performs printing, for example, on a roll of recording paper S using a heat-sensitive type thermal head 510 (see FIG. 4).

The thermal printer 1000 includes the device body 100 and the cover 200. A printer unit 300 including a recording section 310 and a cutting section 320 is disposed at the front, that is, in the -Y direction, of the device body 100 and a recording paper storage section 400 accommodating recording sheets is disposed at the rear, that is, in the +Y direction.

The cover 200 is mounted so as to be pivotable, that is, openable and closable, about a support shaft (not shown) provided at the upper end of the device body 100. The platen roller 520 is disposed at the front of the cover 200. When the cover 200 is closed to the device body 100, the platen roller 520 and the thermal head 510 are brought into contact with each other (see FIG. 4)

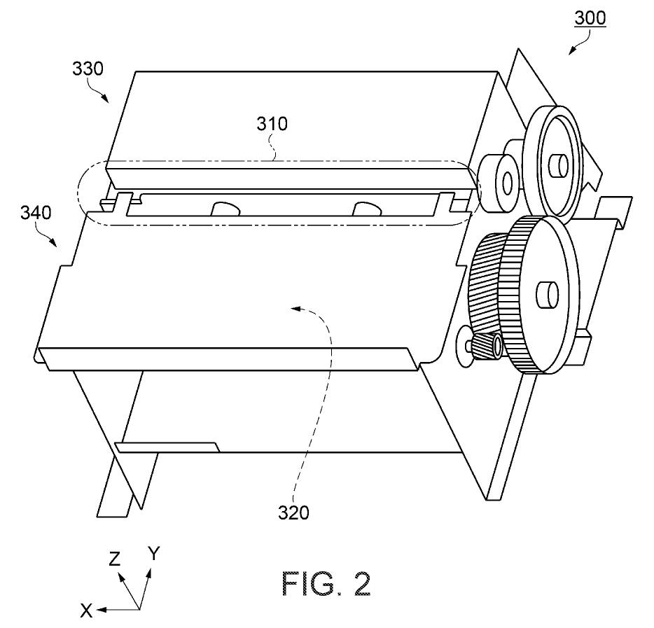

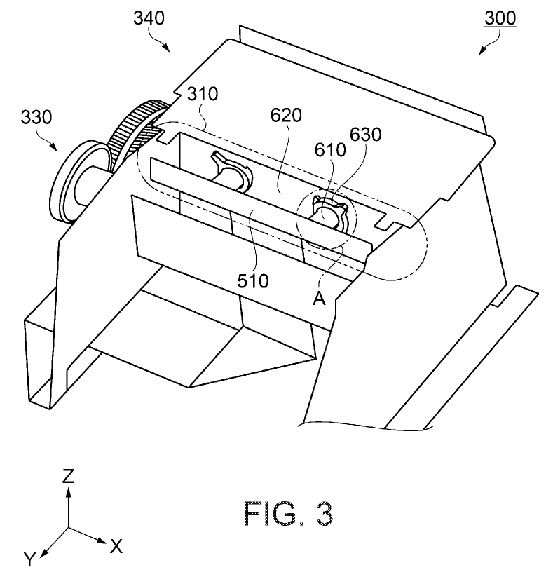

As shown in FIGS. 2 and 3, the printer unit 300 includes a first unit 330 disposed in the +Y direction and a second unit 340 disposed in the -Y direction. The recording section 310 having the thermal head 510 or the like is disposed between the first unit 330 and the second unit 340. Note that the platen roller 520 is included in both the recording section 310 and the first unit 330.

The cutting section 320 is disposed on the second unit 340. As shown in FIG. 3, the recording section 310 includes the thermal head 510, a pressing member 610, a support member 620, and a pressing force adjustment member 630. The thermal head 510 is pivotably supported by the printer unit 300.

Next, the configuration of the recording section 310 will be described with reference to FIG. 4.

As shown in FIG. 4, as described above, the recording section 310 includes the thermal head 510, the platen roller 520, the pressing member 610, the support member 620, and the pressing force adjustment member 630.

The platen roller 520 is disposed so as to face the thermal head 510. The platen roller 520 is, for example, composed of a cylindrical rubber roller. The platen roller 520 is rotatably supported on the cover 200 via a platen frame 521 (see FIG. 1).

The recording sheet S passes between the platen roller 520 and the thermal head 510. The platen roller 520 and the thermal head 510 are configured to sandwich the recording sheet S with a predetermined pressure. The recording sheet S is transported by rotation of the platen roller 520.

The pressing member 610 is, for example, a coil spring. The pressing member 610 is disposed on a side opposite than the platen roller 520 with respect to the thermal head 510. The pressing member 610 is in contact with the thermal head 510 via the head support plate 511, and presses the thermal head 510 toward the platen roller 520.

The support member 620 is disposed on the side opposite than the thermal head 510 with respect to the pressing member 610. The support member 620 is a part of the second unit 340.

The pressing force adjustment member 630 is disposed between the support member 620 and the pressing member 610. The pressing force adjustment member 630 adjusts the pressing force of the pressing member 610.

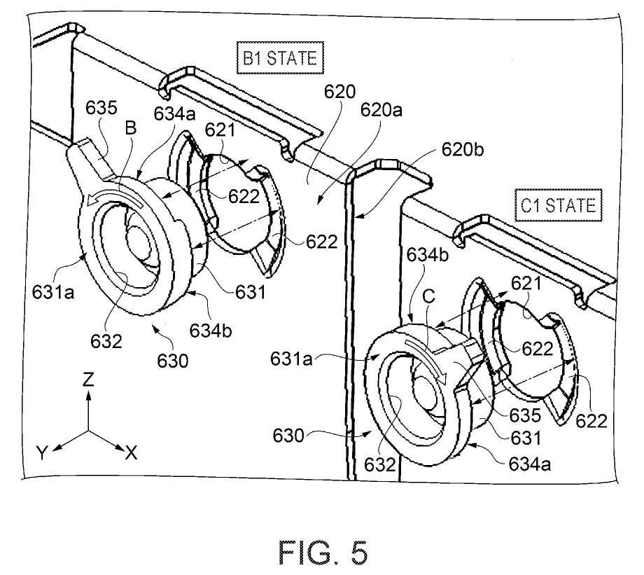

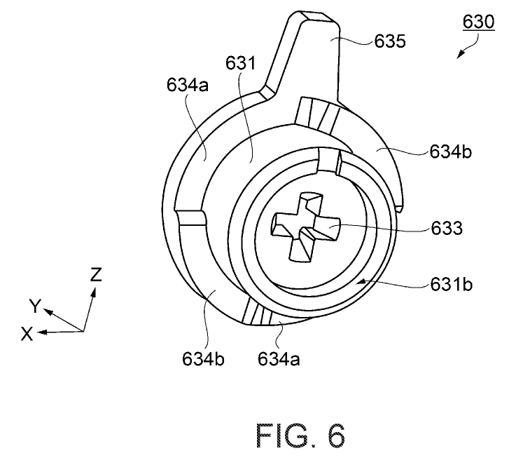

Next, specific configurations of the support member 620 and the pressing force adjustment member 630 will be described with reference to FIGS. 5 and 6.

As shown in FIGS. 5 and 6, the support member 620 is provided with, for example, two through holes 621 from the support surface 620a to the opposite surface 620b facing the support surface 620a. The support member 620 has a support surface 620a for supporting the pressing force adjustment member 630.

Step surfaces 622 are provided at two opposing locations around the through hole 621 in the support surface 620a side of the support member 620. The step surface 622 is formed with a step along the through hole 621.

The pressing force adjustment member 630 includes a shaft section 631 and a recess section 632 provided at one end section 631a of the shaft section 631. The shaft section 631 is rotatably held with respect to an engaged portion, that is, the through hole 621, of the support member 620. The recess section 632 receives one end of the pressing member 610 (see FIG. 4) in the extending and contracting direction. The recess section 632 restricts movement in directions that intersect the extending and contracting direction of the pressing member 610, that is, in the X direction and in the Z direction.

In this way, since one end of the pressing member 610 is received by the recess section 632, it is possible to press to the thermal head 510 side, and it is possible to suppress the pressing force adjustment member 630 from being detached from the support member 620. Further, by receiving one end of the pressing member 610 in the recess section 632, it is possible to suppress the pressing member 610 from being detached from the pressing force adjustment member 630.

As shown in FIG. 6, the other end section 631b, which is on the opposite side of the pressing force adjustment member 630 than the one end section 631a, is provided with an engagement structure 633 with which the tip of a tool can be engaged. Examples of the tool include a Phillips-head screwdriver. The engagement structure 633 is formed in a cross-shaped recessed shape to engage with the tip of a Phillips-head driver.

In this way, since the engagement structure 633 is provided at the other end section 631 b of the pressing force adjustment member 630, the pressing force adjustment member 630 can be rotated by using a tool from a direction opposite from the pressing member 610 in the supporting member 620.

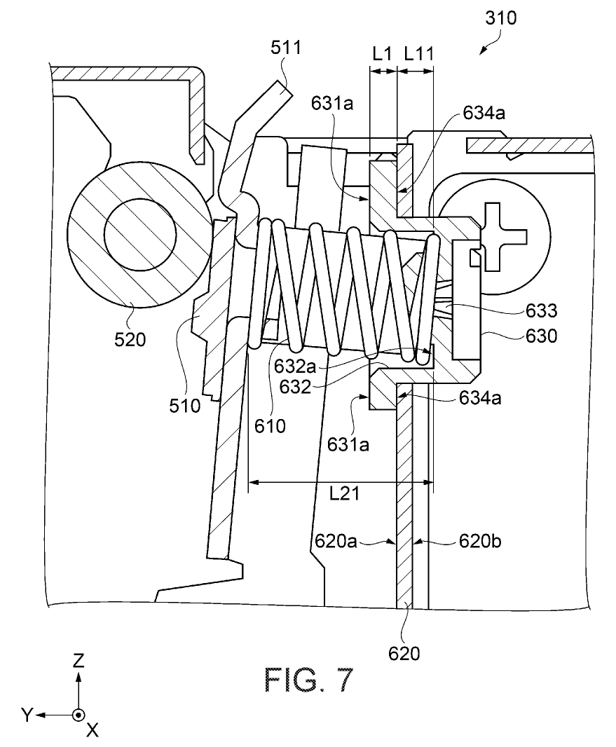

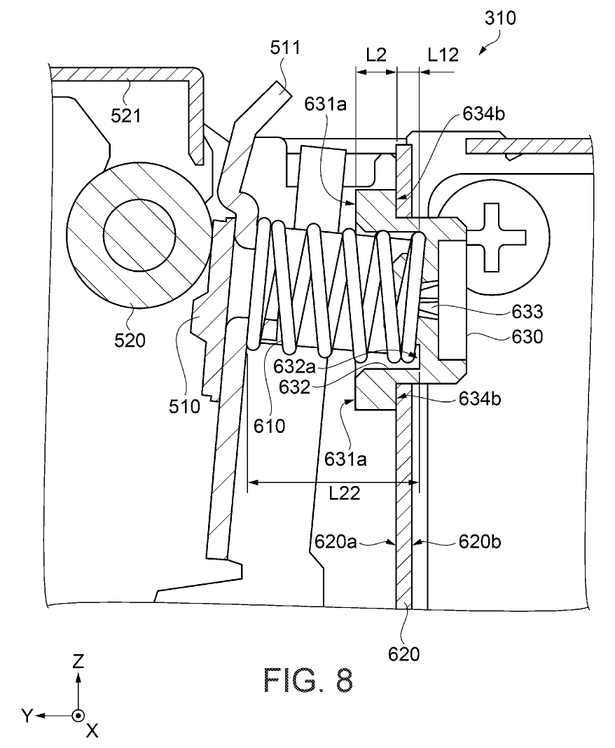

The pressing force adjustment member 630 has a first surface 634a and a second surface 634b opposed to the support surface 620a. The first surface 634a corresponds to a position at a distance L1 from the one end section 631a of the pressing force adjustment member 630 (see FIG. 7). The second surface 634b corresponds to a position at a distance L2 from the one end section 631a of the pressing force adjustment member 630 (see FIG. 8).

In other words, the first surface 634a is longer than the second surface 634b by a distance L11 from a bottom surface 632a of the recess section 632. That is, the distance L11 from the first surface 634a to the bottom surface 632a is greater than the distance L12 from the second surface 634b to the bottom surface 632a (see FIGS. 7 and 8).

When the first surface 634a of the pressing force adjustment member 630 is supported with respect to the support surface 620a of the support member 620, the amount of deflection of the pressing member 610 is small, and the pressing force to the thermal head 510 is weak. On the other hand, when the second surface 634b of the pressing force adjustment member 630 is supported with respect to the support surface 620a of the support member 620, the amount of deflection of the pressing member 610 is increased, the pressing force to the thermal head 510 is strong.

As shown in FIGS. 5 and 6, a projection-shaped operation section 635 is provided on the periphery of the shaft section 631 of the pressing force adjustment member 630 on the one end section 631a side. The operation section 635 is a size that allows a user to pinch it with a finger and pivot it in a B direction or a C direction.

As described above, since the operation section 635 is provided on the shaft section 631, the pressing force of the pressing member 610 can be adjusted by operating the operation section 635 to pivot the pressing force adjustment member 630.

Next, a method of adjusting the pressing force of the thermal head 510 to the platen roller 520 will be described with reference to FIGS. 7 and 8. The diagram shown in FIG. 7 illustrates the configuration of the recording section 310 in a state where the pressing force of the pressing member 610 is weak. The diagram shown in FIG. 8 illustrates the configuration of the recording section 310 in a state where the pressing force of the pressing member 610 is strong.

As shown in FIG. 7, the recording section 310 is disposed with the thermal head 510 facing the platen roller 520, as described above. The thermal head 510 is pressed, that is, urged to the platen roller 520 side by the pressing member 610.

The thermal head 510 is connected to the pressing member 610 via the head support plate 511. The pressing member 610 is sandwiched between the head support plate 511 and the pressing force adjustment member 630. The pressing force adjustment member 630 is rotatably held by the support member 620.

When it is desired to weaken the pressing force of the thermal head 510 against the platen roller 520, then as shown in FIG. 5, the pressing force adjustment member 630 is rotated in the B direction. Specifically, the first surface 634a of the pressing force adjustment member 630 and the support surface 620a of the support member 620 are brought into contact with each other. Further, the second surface 634b of the pressing force adjustment member 630 is brought into contact with the step surface 622. That is, as shown in FIG. 7, the pressing force adjustment member 630 is disposed so as to have the relationship between the pressing force adjustment member 630 and the support member 620.

The rotation method of the pressing force adjustment member 630, as described above, may be rotated using a tool, or it may be operated by pinching the operation section 635 with a finger.

Thus, the distance L21 from the bottom surface 632a of the recess section 632 of the pressing force adjustment member 630 to the head support plate 511 is longer than the distance L22 in the C1 state (see FIG. 8). Therefore, the amount of deflection of the pressing member 610 is reduced, and the pressing force of the thermal head 510 to the platen roller 520 can be weakened.

Next, an adjustment method in a case where the pressing force of the thermal head 510 against the platen roller 520 is to be increased will be described. As shown in FIG. 5, the pressing force adjustment member 630 is rotated in the C direction. Specifically, the first surface 634a of the pressing force adjustment member 630 and the step surface 622 of the support member 620 are adjusted to face each other.

Further, the second surface 634b of the pressing force adjustment member 630 and the support surface 620a of the support member 620 are brought into contact. That is, as shown in FIG. 8, the pressing force adjustment member 630 is disposed so as to have the relationship between the pressing force adjustment member 630 and the support member 620.

The rotation method of the pressing force adjustment member 630, as described above, may be rotated using a tool, or it may be operated by pinching the operation section 635 with a finger.

As a result, the distance L22 from the bottom surface 632a of the recess section 632 of the pressing force adjustment member 630 to the head support plate 511 is shorter than the distance L21 in the B1 state (see FIG. 7). Therefore, the amount of deflection of the pressing member 610 is increased, and the pressing force of the thermal head 510 to the platen roller 520 can be increased.

In this way, by using the first surface 634a and the second surface 634b provided on the pressing force adjustment member 630 to change the surface supported by the support surface 620a, the pressing force of the thermal head 510 against the platen roller 520 can be adjusted to be weaker or stronger. For example, when the recording paper S is one that could damage the thermal head 510, the pressing force is reduced. When the stiffness of the recording paper S is strong or when the recording paper S is thick, the pressing force is increased. As described above, a thermal printer 1000 of the present embodiment includes a thermal head 510 pivotably supported by the printer unit 300, a platen roller 520 that is disposed opposite to the thermal head 510 and that trasports a recording sheet S, a pressing member 610 that is provided on the side opposite to the platen roller 520 with respect to the thermal head 510 and that presses the thermal head 510 toward the platen roller 520, a support member 620 provided on a side opposite than the thermal head 510 with respect to the pressing member 610, and a pressing force adjustment member 630 disposed between the support member 620 and the pressing member 610 to adjust the pressing force of the pressing member 610.

According to this configuration, since the pressing force adjustment member 630 is provided and the pressing force of the thermal head 510 against the platen roller 520 can be changed, it is possible to reduce the number of parts compared to the conventional configuration that is composed of multiple adjustment parts, and the pressing force can be adjusted with a relatively simple configuration. Since the pressing force of the pressing member 610 is adjusted with the pressing force adjustment member 630 fitted into the through hole 621 of the support member 620, the pressing force adjustment member 630 will not separate from the printer unit 300, and it is possible to suppress the loss at the time of adjustment. Additionally, in the thermal printer 1000 of the present embodiment, it is preferable that the pressing force adjustment member 630 includes a shaft section 631 and a recess section 632 provided at one end section 631a of the shaft section 631, that the shaft section 631 is rotatably held with respect to the through hole 621 of the support member 620, and that the recess section 632 receives one end of the pressing member 610 to restrict movement in a direction intersecting the extending and contracting direction of the pressing member 610.

According to this configuration, since the recess section 632 receives one end of the pressing member 610, it is possible to press to the thermal head 510 side, and the pressing force adjustment member 630 can be suppressed from separating from the support member 620. Further, by being received in the recess section 632, it is possible to suppress the pressing member 610 from separating from the pressing force adjustment member 630.

Additionally, in the thermal printer 1000 of the present embodiment, it is preferable that the engaged portion is a through hole 621, and an engagement structure 633 with which the tip of a tool can be engaged is provided at the other end section 631b of the shaft section 631, which is the opposite from the one end section 631a.

According to this configuration, since the shaft section 631 is provided with the engagement structure 633, the pressing force adjustment member 630 can be operated by the tip of a tool. In the thermal printer 1000 of the present embodiment, it is preferable that at least one operation section 635 is provided on the shaft section 631. According to this configuration, since the shaft section 631 is provided with the operation section 635, the pressing force of the pressing member 610 can be adjusted, for example, by operating the operation section 635 to rotate the pressing force adjustment member 630.

In the thermal printer 1000 of this embodiment, the support member 620 has a support surface 620a that supports the pressing force adjustment member 630, the pressing force adjustment member 630 has a first surface 634a and a second surface 634b facing the support surface 620a, the first surface 634a is a longer distance L11 from the bottom surface 632a of the recess section 632 than the second surface 634b compared to the distance L12, when the first surface 634a is supported with respect to the support surface 620a, the pressing force becomes weak, when the second surface 634b is supported with respect to the support surface 620a, the pressing force becomes strong.

According to this configuration, by using the first surface 634a and the second surface 634b provided on the pressing force adjustment member 630 to change the surface supported by the support surface 620a, the pressing force against the platen roller 520 of the thermal head 510 can be weaker or stronger. Specifically, when the second surface 634b is supported, the distance from the bottom surface 632a of the recess section 632 to the thermal head 510 is shortened, and the pressing force of the pressing member 610 becomes strong.

Hereinafter, a modification of the above-described embodiment will be described.

As described above, the pressing force adjustment member 630 is configured to the two surfaces of the first surface 634a and the second surface 634b, but is not limited thereto, and may configured to one or more surfaces with a height other than the first surface 634a and the second surface 634b.

As described above, the pressing member 610 is not limited to a coil spring, and a leaf spring or the like may be used.

What is claimed is:

1. A thermal printer comprising:
a thermal head pivotably supported by a printer unit;
a platen roller that is disposed opposite to the thermal head and that is configured to transport a recording sheet;
a pressing member that is provided on a side opposite than the platen roller with respect the thermal head and that is configured to press the thermal head toward the platen roller;
a supporting member provided on a side opposite than the thermal head with respect to the pressing member; and
a pressing force adjustment member that is disposed so as to be sandwiched between the supporting member and the pressing member and that is configured to adjust pressing force of the pressing member.

2. The thermal printer according to claim 1, wherein
the pressing force adjustment member includes a shaft section and a recess section provided at one end section of the shaft section,
the shaft section is rotatably held with respect to an engaged portion of the supporting member, and
the recess section is configured to receive one end of the pressing member, to restrict movement in a direction intersecting an extending and contracting direction of the pressing member.

3. The thermal printer according to claim 2, wherein
the engaged portion is a through hole and
an engagement structure with which a tip of a tool is engageable is provided at an other end section of the shaft section opposite from a one end section of the shaft section.

4. The thermal printer according to claim 2, wherein
the shaft section is provided with at least one operation section.

5. The thermal printer according to claim 2, wherein
the supporting member has a support surface that supports the pressing force adjustment member,
the pressing force adjustment member has a first surface and a second surface that face the support surface,
the first surface is a longer distance from the bottom surface of the recess section than is the second surface,
when the first surface is supported with respect to the support surface, the pressing force becomes weak, and
when the second surface is supported with respect to the support surface, the pressing force becomes strong.
